(19) United States
(12) Patent Application Publication
(10) Pub. No.: US 2005/0039645 A1
(43) Pub. Date: Feb. 24, 2005

(54) Pallet rack workbench

(76) Inventors: Thomas Alan Bulk, Colorado Springs, CO (US); Kevin Patrick Sheahan, Colorado Springs, CO (US)

Correspondence Address: Thomas A Bulk, 20798 Amberview Ct, Ashburn, VA, 20147, US

(21) Appl. No.: 10/643,143

(22) Filed: Aug. 18, 2003

(51) Int. Cl. A47B 5/00; B25H 1/00

(52) U.S. Cl. 108/152

(57) ABSTRACT

A workbench of pallet rack construction where the front to back distance between vertical posts is set to accommodate an integral number of off-the-shelf lumber pieces to be laid side by side and parallel to the cross members as a work surface. Cross members containing and upper and lower lip enable the workbench top surface to be continuous from front to back, minimizing the gaps between lumber pieces and allowing off-the-shelf lumber pieces to support the lumber pieces used for the top surface. An additional right angle brace spanning from the front to back horizontal cross member and attaching to the cross members prevents disengagement of the cross members under table top vibration, and allows for a continuous workbench surface by enabling a butt joint for two sets of commercial off-the-shelf lumber spanning in either direction from the center of the vertical posts.

### CROSS-REFERENCE TO RELATED APPLICATIONS

Reference U.S. patent application Ser. No. 09/775,753 entitled Workbench and filed pro se Feb. 5, 2001. The patent referenced addresses a workbench leg with a specified quantity of dimensional lumber pieces spanning its top surface, and also having the ability to create a butt joint at the center of the leg for dimensional lumber pieces spanning right and left from the center of the leg.

### FEDERAL SPONSORED RESEARCH OR DEVELOPMENT

This invention is not related to any federal sponsored research or development.

### BACKGROUND OF THE INVENTION

In a pallet rack system, it is common for the horizontal connecting structures that attach between upright column members to contain a lip for retaining off-the-shelf commercial lumber boards to span between the front and rear horizontal connecting structures, such as that shown in U.S. Pat. Nos. 3,351,212 and 5,350,074. The commercial off-the-shelf lumber boards also referred to as “dimensional lumber” or “framing lumber,” span front to back of a pallet rack so that a pallet can be laid and slid across the boards without catching the edge of the boards. The ability to slide a pallet across the support surface would not be the case if the lumber were laid side by side horizontal to the cross members and between the front and rear vertical posts. In a pallet rack system, no attempt is made in the previous art to place lumber boards lengthwise spanning left to right and horizontal to the cross members, nor is there a need to have dimensional lumber to pass unimpeded between the front or rear vertical posts since the intent of the pallet rack construction defined by the previous art is for supporting pallet racks. A review of previous patents indicates the previous art was concerned with improving the structure, the means of attachment of the horizontal cross members, and the means of securing the horizontal cross members to the vertical posts. This is presented in U.S. Pat. Nos. 3,351,212, 3,392,848; 3,414,224; 3,741,405; 4,074,812; 4,708,252; 5,025,937; 5,131,781; 5,713,476; 5,791,502; 5,938,367; 6,230,910; and 6,352,164.

Common to the prior art and applicable to placing lumber front to back, is the horizontal cross members. These structures are comprised of a formed steel beam containing a lip and two L-shaped flanges mounted perpendicular to the beam, typically by means of a weld. Protrusions equally spaced and located on the L-shaped flange forms the means of attachment to the equally spaced apertures located on the upright column members. Further shown in U.S. Pat. Nos. 4,729,484 and 5,350,074, is that the horizontal supporting structures spanning left to right and attaching to the vertical posts have the lumber support lip positioned in between the vertical posts. As shown, either the L-shaped brackets attached on each end of the horizontal connecting structures prevent a board from passing unimpeded between the vertical uprights, or the vertical posts themselves present motion of the boards between the vertical posts. Preventing such motion is desirable in pallet rack construction used as a pallet rack, but for a workbench of pallet rack construction such a design is not desirable since the workbench surface cannot be continuous between the front and rear vertical posts. Furthermore, the previous pallet rack art provides no suitable means of securing the dimensional lumber that is laid from the front cross member to the back cross member.

The purpose of this invention is to create a workbench of pallet rack construction comprised of dimensional lumber laid side by side and parallel to the cross members. By setting the work surface front to back distance to allow an integral number of dimensional lumber pieces to lay side by side as the work surface along with improvements to the cross members, a rugged workbench table top comprised of dimensional lumber spanning parallel to the cross member and unimpeded between the vertical posts is obtained. An additional flange or lip positioned below the shelf lip on the cross members allows commercially available dimensional lumber to also function as a structural support member for the upper work surface created of dimensional lumber. Wood screw holes set in a pattern to acquire a particular dimensional lumber type and located on the cross member upper and lower lips provides suitable capture and minimizes wood splitting and warp. A right angle brace spanning from the front cross member to the back cross member and attaching to the cross member bracket wall prevents disengagement of the cross members from table top vibration and sets the dimensional lumber attachment height to the height of the cross member upper lip.

### BRIEF SUMMARY OF INVENTION

This invention presents a workbench of pallet rack construction comprising horizontal connecting structures, upright column members, and a workbench surface of one or more dimensional lumber boards that pass unimpeded between the front and back vertical posts. Improvements in the horizontal connecting structure helps minimize work surface gaps while incorporating a second lip below the upper lip to utilize a support brace for the upper dimensional lumber boards also of dimensional lumber and running lengthwise between the front and back cross members. A right angle brace spanning front to back attaches to the front and rear cross member preventing the cross members from disengagement under table top vibration.

### BRIEF DESCRIPTION OF THE DRAWINGS

The accompanying drawings illustrate preferred embodiments of the invention according to the practical application of the principles thereof and in which:

FIG. 1 is a perspective view of a front portion of a pallet rack system comprising two vertical uprights, a cross member between the vertical uprights and the other components comprising the present invention.

FIG. 2 is a perspective underside, internal to external view of a portion of a pallet rack system.

FIG. 3 is a perspective view of the horizontal cross member shown in FIG. 1.

FIG. 4 is a perspective view of the angle support brace shown in FIG. 2.

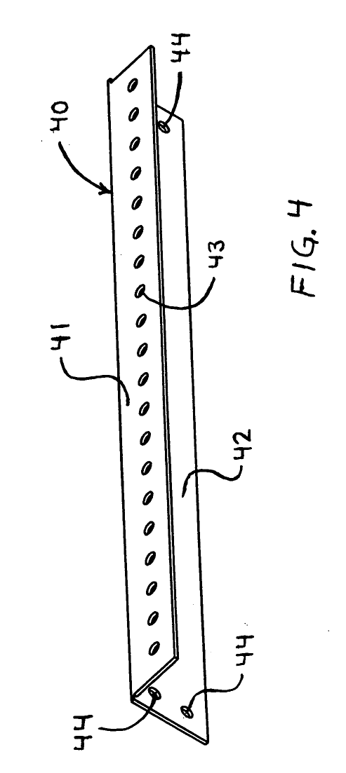

### DETAILED DESCRIPTION OF THE INVENTION

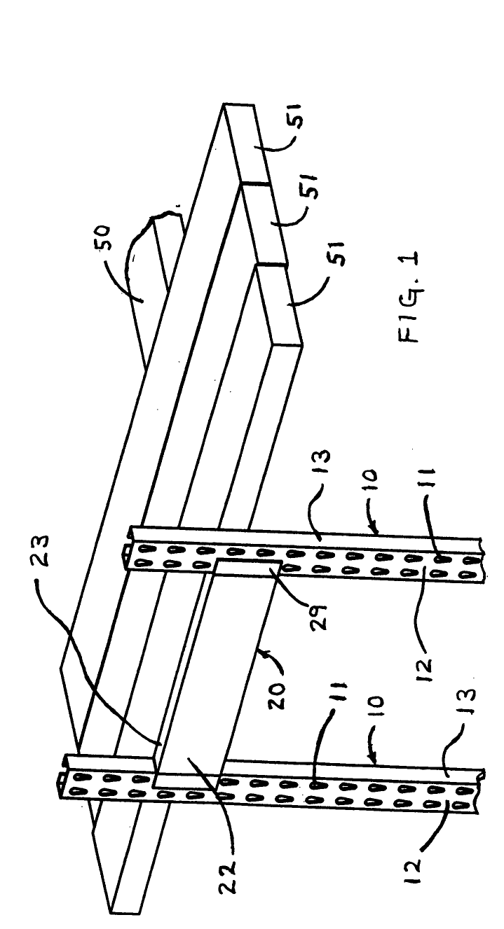

A portion of rack system is shown in FIG. 1 comprising two vertical posts 10, a horizontal cross member 20, a right angle brace 40, three dimensional lumber shelf boards 51, and a dimensional lumber support board 50. As depicted in U.S. Pat. Nos. 3,871,525 and 5,713,476 and known to the art, each side of the rack constitutes a front and back vertical post 10 attached by U-shaped front to back metal members that set the front to back depth of the pallet rack system and create a vertical structure often referred to as a single pallet rack “vertical upright”. As shown in U.S. Pat. No. 5,350,074, the U-shaped brackets are welded to the vertical posts 10 in the region where the U-shaped metal brace intersect the vertical post 10, in-turned lip surface 14. Improvements by the present invention create a pallet rack style workbench comprised of dimensional lumber, sometimes defined as “framing” lumber, whose dimensions are defined by the American Lumber Standard. In doing so, the distance between a front and back vertical post in-turned lip surface 14 is set to an integral number of dimensional lumber boards 51 times the width of the lumber and a tolerance to account for the lumber moisture content and wood warp. This enables the dimensional lumber shelf boards 51 to lie parallel to the horizontal cross members 20 and unimpeded between the vertical posts 10, while also minimizing the gap between the vertical posts 10 and the sides of the dimensional lumber shelf boards 51 laid closest to the vertical posts 10.

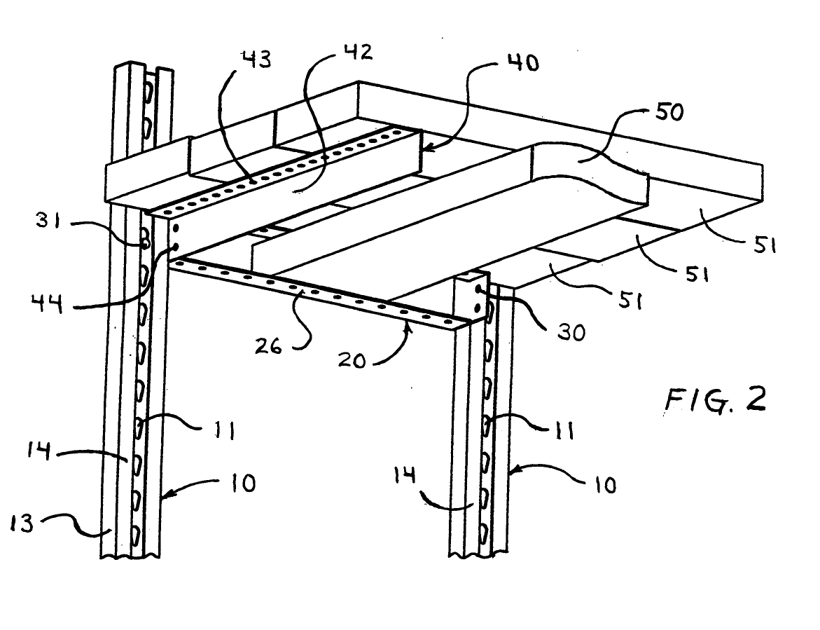

Each vertical post 10 is a formed steel channel with a rectangular cross section having an external wall 12, two side walls 13, and in-turned lips 14 FIG. 2. The vertical post external wall 12 of the vertical posts 10 contains two rows of vertically displaced apertures 11, generally of a key hole shape and vertically symmetrical about the vertical axis FIG. 1. The apertures 11 along the vertical post 10 are equally spaced and are of a tear drop shape with a large opening at the top tapering down to a smaller opening at the bottom. Spanning between two vertical posts 10 either in the front or rear of the rack system are the horizontal cross members 20.

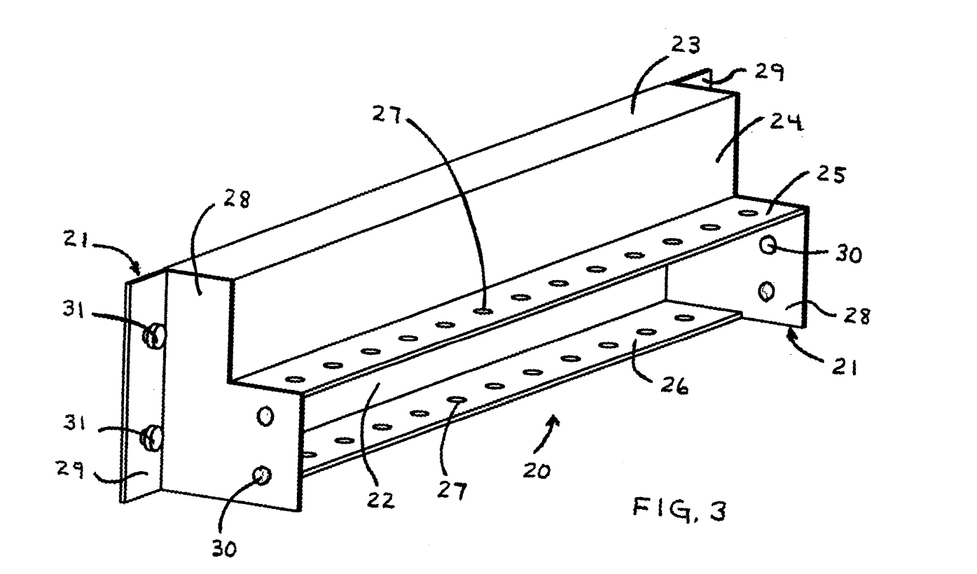

As shown in FIG. 3, the horizontal cross members 20 are made of roll formed steel and comprised of an outer wall 22, an upper surface 23, an inner wall 24, an upper lip 25, a lower lip 26, and two cross member brackets 21. Each cross member bracket 21 is an L-shaped bracket comprised of a cross member bracket wall 28 and a cross member bracket flange 29. The L-shaped bracket constitutes a corner that butts up to the vertical post side 13 and vertical post outer face 12 FIG. 1-2. Two or more rivets 31 located on the cross member bracket flange 29 when inserted fully into the equally spaced apertures 11 located on the vertical posts 10 engage either two front or two back vertical posts 10 creating a rigid attachment, as shown in FIG. 1-2.

FIG. 2 shows a rear perspective view of the front portion of the rack system. Positioned and running parallel to the horizontal cross member 20 are dimensional lumber shelf boards 51. The previous art in rack construction shows a lip on the cross members that provide containment for a wood board resting on the lip; however, the positioning of the lip and the welded brackets located at each end of the metal rolled formed cross members prevents the a plywood board or lumber boards from laying unimpeded between the vertical posts. Several improvements in the horizontal cross member 20 defined by the present invention enable dimensional lumber shelf boards 51 to be placed parallel to the horizontal cross member allowing for unimpeded routing between a front and rear vertical post 10. As shown in FIG. 1 and FIG. 3, the cross member upper surface 23 is extended inward towards the center of the rack system at a distance equivalent within some manufacturing tolerance to the width of the vertical post side wall 13. When using a pallet rack design as a workbench surface, minimizing the gap between the cross member inner wall 24 and the sides of the dimensional lumber shelf boards 51 closest to the wall prevents objects from falling within the gap. By extending the cross member upper surface 23, the cross member upper lip 25 initiates inward at a position in the pallet rack construction equivalent within some tolerance to that of vertical post in-turned lip surface 14 FIG. 2. Regardless of whether dimensional lumber shelf boards 51 or plywood is laid on the cross member upper lip 25, the cross member upper lip 25 as shown in the present invention must initiate at a position to clear the vertical posts 10. In addition and to allow dimensional lumber to lay horizontal to the cross members 20 and unimpeded between the vertical posts 10, the cross member bracket wall 28 must not extend inward to the center of the rack beyond the cross member inner wall 24 or above the cross member upper lip 25. As one skilled in the art would expect, care needs to be exercised in welding of the cross member bracket wall 28 to the roll formed metal cross member so as not to impede travel of the dimensional lumber shelf boards 51.

As shown in FIG. 1-2, for a workbench to be rugged with a sturdy work surface that can withstand significant weight or vibration, it is desirable to use dimensional lumber as shelf boards 51 because it is readily available, has a wood grain structure to improve structural loading, and comes in various lengths. It is also desirable to make the work surface a continuous flat surface from the front to the back. A continuous work surface is accomplished in the present invention by setting the cross member inner wall 24 to the thickness of dimensional lumber shelf boards 51 as defined by the American Lumber Standard FIG. 1, or if desired to the thickness of plywood as also defined by the American Lumber Standard. As shown in FIG. 2, increased structural stiffness is accomplished by using the dimensional lumber support board 50 as a brace for the dimensional lumber shelf boards 51. The dimensional lumber support board 50 spans from the front cross member lower lip 26 to a back cross member lower lip 26. As shown in FIG. 3, positioning of the dimensional lumber support board 50 is accomplished by creating a cross member lower lip 26, with the lower lip positioned below the upper lip 25 a dimensional distance equivalent to the height of dimensional lumber as defined by the American Lumber Standard plus some manufacturing tolerance. A pattern of holes 27 created for a particular width of dimensional lumber and the pattern repeated periodically along the length of the lower lip allows for the lumber boards to be rapidly secured to the lip with wood screws while preventing the wood screws from splitting or warping the dimensional lumber support boards. This eliminates the need for the user and or consumer to drill holes that align properly with the placement of the boards. A similar pattern of holes is applied to the cross member upper lip 25 so that the end user can utilize the cross member upper lip 25 with similar functionality as the cross member lower lip 26.

Desirable in a workbench of pallet rack construction is to prevent disengagement of the cross members 20 under vibration created by power tools or hammering on the work surface. Also of similar importance is to provide a continuous work surface and a flat work surface routing left to right of a particular vertical post or upright structure. As shown in FIG. 2, this is accomplished by the right angle brace 40 that attaches to the front and back cross members 20. A pair of right angle brace mounting holes 44 located on the right angle brace side 42 enable the right angle brace 40 to attach by a bolted joint with the cross member 20 using cross bracket mounting holes 30, thus preventing disengagement of the horizontal cross members 20. Because the dimensional lumber support boards 50 sit below the horizontal cross member upper lip 25, the right angle brace 40 can be used as the right and left supports to maintain a relatively constant tabletop height. In a configuration of 6 or more vertical posts, two right angle braces 40 can used in conjunction with a front and back vertical post or “vertical upright” to create a butt joint for the dimensional lumber shelf boards 51 spanning right and left of the vertical posts. Similar to the cross member upper 25 and lower lips 26, a pattern of holes 43 created for a particular size of dimensional lumber and the pattern repeated periodically along the length of the right angle brace flange 41 allows for the dimensional lumber shelf boards 51 to be rapidly secured to the lip with wood screws. The benefit of such a predefined pattern is to eliminate for the user having to drill additional holes to prevent splitting the dimensional lumber shelf boards 51 by screw insertion or wood warp from inadequate capture of the shelf boards.

1. In a rack structure comprising rectangular vertical posts, said posts with equally spaced apertures on the vertical post front face, and cross members having end brackets, said brackets containing rivets or some other protrusion equally spaced for interconnecting with apertures on the vertical post front face, an improved right or left vertical upright comprised of two vertical posts with welded support braces, said distance between the in-turned lip surface of the front and rear vertical posts equivalent to an integral number of a particular type of dimensional lumber pieces times the width dimensions defined by the American Lumber Standard, and some tolerance to cover wood moisture content and board warp.

2. In a rack structure comprising rectangular vertical posts, said posts with equally spaced apertures on the vertical post front face, and cross members having end brackets, said brackets containing rivets or some other protrusion equally spaced for interconnecting with apertures on the vertical post front face, an improved cross member for creating a workbench like continuous work surface that can extend between vertical posts, cross member comprising a formed steel structure having an outer wall, upper surface, inner wall, upper lip, lower lip, and cross member bracket; said cross member upper surface extended inward to the center of the rack, said distance equal within some reasonable manufacturing tolerance to the vertical post side wall width, said distance set in order to minimize the gap between the cross member inner wall and the dimensional lumber laid side by side, parallel to cross members, and spanning between the front and rear vertical posts.

3. In a rack structure comprising rectangular vertical posts, said posts with equally spaced apertures on the vertical post front face and cross members having end brackets, said brackets containing rivets or some other protrusion equally spaced for interconnecting with apertures on the vertical post front face, an improved cross member for creating a workbench like continuous work surface that can extend between vertical posts, said cross member comprising a formed steel structure having an outer wall, upper surface, inner wall, upper lip, lower lip, and cross member bracket; said cross member bracket wall material removed in region above upper lip and not extending beyond cross member inner wall so dimensional lumber laid side by side, parallel to cross members, and spanning between front and rear vertical posts can butt up to the vertical post in-turned lip surface.

4. In a rack structure comprising rectangular vertical posts, said posts with equally spaced apertures on the vertical post front face, and cross members having end brackets, said brackets containing rivets or some other protrusion equally spaced for interconnecting with apertures on the vertical post front face, an improved cross member for creating a workbench like continuous work surface that can extend between vertical posts, cross member comprising a formed steel structure having an outer wall, upper surface, inner wall, upper lip, lower lip, and cross member bracket, said lower lip constituting a flange extending from outer wall and positioned below upper lip to a depth equivalent within some manufacturing tolerance to the American Standard Lumber thickness for a particular type of dimensional lumber boards, said lip enabling dimensional lumber to be used as a support brace spanning horizontally between front and back cross members.

5. In a rack structure comprising rectangular vertical posts, said posts with equally spaced apertures on the vertical post front face, and cross members having end brackets, said brackets containing rivets or some other protrusion equally spaced for interconnecting with apertures on the vertical post front face, an improved cross member for creating a workbench like continuous work surface that can extend between vertical posts, cross member comprising a formed steel structure having an outer wall, upper surface, inner wall, upper lip, lower lip, and cross member bracket; said cross member upper and lower lip containing a pattern of holes to capture and prevent splitting of a particular dimensional lumber type and said pattern repeated periodically throughout the length of the lip on the cross member.

6. In a rack structure comprising rectangular vertical posts and having vertical posts with equally spaced apertures on the vertical post front face and cross members having end brackets, with said brackets containing rivets or some other protrusion equally spaced for interconnecting with apertures on the vertical post front face, a right angle brace attached from front cross member bracket side wall to rear cross member side wall to prevent disengagement of cross members, said right angle brace flange positioned at the cross member upper lip height to provide end support for dimensional lumber spanning between vertical posts.

7. A right angle brace as in claim 6, wherein the right angle brace flange contains a pattern of holes to capture and prevent splitting of a particular dimensional lumber type and said pattern repeated periodically throughout the length of the flange.
